(19) United States
(12) Patent Application Publication
(10) Pub. No.: US 2025/0202579 A1
(43) Pub. Date: Jun. 19, 2025

(54) CONTROL APPARATUS, COMMUNICATION SYSTEM AND CONTROL METHOD

(71) Applicant: NIPPON TELEGRAPH AND TELEPHONE CORPORATION, Tokyo (JP)

(72) Inventors: Rintaro HARADA, Musashino-shi (JP); Naotaka SHIBATA, Musashino-shi (JP); Takeshi IMAI, Musashino-shi (JP); Shin KANEKO, Musashino-shi (JP)

(73) Assignee: NIPPON TELEGRAPH AND TELEPHONE CORPORATION, Tokyo (JP)

(21) Appl. No.: 18/847,713

(22) PCT Filed: Mar. 28, 2022
(86) PCT No.: PCT/JP2022/014871

§ 371 Date: Sep. 17, 2024

(51) Int. Cl. H04B 10/112

(52) U.S. Cl. CPC H04B 10/1127

(57) ABSTRACT

A control device includes: a distance derivation part which derives a communication distance between a subject-communication device which communicates using a beam and another communication device which faces the subject communication device; a speed derivation part which derives a relative speed of the another communication device with respect to the subject communication device; an angle derivation part which derives a range of divergence angles of a beam in which it is possible to maintain communication between the subject communication device and the another communication device on the basis of at least the communication distance and the relative speed; and an angle control part which changes a divergence angle of the beam when it is determined that the divergence angle needs to be changed on the basis of the current divergence angle of the beam and the range.

### TECHNICAL FIELD

The present invention relates to a control apparatus, a communication system and a control method.

### BACKGROUND ART

In free space optics (FSO), a communication device (subject communication device) uses optical signals (beams) which propagate in a free space to communicate with other communication devices facing it. The beam transmitted from the transmission part of the subject communication device is received by the reception part of the other communication device at a predetermined reception diameter. Here, the beam diverges in accordance with the communication distance (propagation distance of the optical signal).

When a beam with a reception power necessary for communication is received by the reception part, communication can be maintained. Furthermore, the power (light intensity) is strongest at the optical axis of the beam and the further away from the optical axis of the beam, the weaker the power becomes. For this reason, when the optical axis of the beam is more than a certain distance from the center of the reception part (when the optical axis deviation is large), the reception part cannot receive the beam with the reception power necessary for communication, making it impossible to maintain communication.

When a communication device is installed in a mobile object, in order to maintain communication using the communication device, it is necessary for the transmission part to direct the beam in the direction of the reception part while communication is possible (while the optical axis deviation is small). In order to maintain communication, the transmission part performs control to direct the beam toward the reception part with a predetermined period.

In order to maintain communication, the faster the moving speed of the communication device is, the shorter the period of execution of control for directing the beam needs to be. However, the shorter the period of execution of the control to direct the beam, the more difficult the control becomes.

Furthermore, the shorter the communication distance, the smaller the beam divergence. Therefore, the shorter the communication distance, the smaller the optical axis deviation allowed to maintain communication. For this reason, the shorter the communication distance, the shorter the execution cycle time of the control for directing the beam needs to be. As described above, the shorter the execution cycle time of the control for directing the beam, the more difficult the control becomes.

Therefore, a technique which dynamically controls the divergence angle of a beam in accordance with the moving speed and the communication distance of a communication device has been proposed (refer to PTD 1). The transmission part derives the optimal divergence angle of the beam on the basis of the known distance (communication distance) between the communication devices and the relative speed between the communication devices. The transmission part controls the divergence angle of the beam output from the laser so that the beam divergence angle is optimized.

### CITATION LIST

### Patent Document

PTD 1: WO 2022/038678

### SUMMARY OF INVENTION

### Technical Problem

The transmission part increases the divergence angle of the beam as the known distance between the communication devices becomes shorter. Furthermore, the transmission part increases the divergence angle of the beam as the relative speed between the communication devices increases. Thus, the communication between communication devices can be maintained without shortening the execution cycle time of beam directing control.

However, a timing decision policy and a control method for controlling the beam divergence angle to enable communication to be maintained has not been established. Furthermore, when the divergence angle is controlled using mechanical parts, the increased number of times the beam divergence angle is controlled increases wear on mechanical parts, shortening the lifespan of the communication system.

In view of the above circumstances, an object of the present invention is to provide a control device, a communication system, and a control method which can reduce the number of times the beam divergence angle is controlled.

### Solution to Problem

An aspect of the present invention is a control device including: a distance derivation part which derives a communication distance between a subject communication device which communicates using a beam and another communication device which faces the subject communication device; a speed derivation part which derives a relative speed of the another communication device with respect to the subject communication device; an angle derivation part which derives a range of divergence angles of a beam in which it is possible to maintain communication between the subject communication device and the another communication device on the basis of at least the communication distance and the relative speed; and an angle control part which changes a divergence angle of the beam when it is determined that the divergence angle needs to be changed on the basis of the current divergence angle of the beam and the range.

An aspect of the present invention is a communication system which includes a subject communication device which communicates using a beam and another communication device facing the subject communication device. The subject communication device includes: a distance derivation part which derives a communication distance between the subject communication device and another communication device facing the subject communication device; a speed derivation part which derives a relative speed of the another communication device with respect to the subject communication device; an angle derivation part which derives a divergence angle range of the beam in which it is possible to maintain communication between the subject communication device and the another communication device on the basis of at least the communication distance and the relative speed; and an angle control part which changes a divergence angle of the beam when it is determined that the divergence angle needs to be changed on the basis of the current divergence angle of the beam and the range, and the another communication device includes: a reception part which acquires the beam from the angle control part.

An aspect of the present invention is a control method performed by the control device including: a step of deriving a communication distance between a subject communication device which communicates using a beam and another communication device facing the subject communication device; a step of deriving a relative speed of the another communication device with respect to the subject communication device; a step of deriving a divergence angle range of the beam in which it is possible to maintain communication between the subject communication device and the another communication device on the basis of at least the communication distance and the relative speed; and a step of changing a divergence angle of the beam when it is determined that the divergence angle needs to be changed on the basis of the current divergence angle of the beam and the range.

### Advantageous Effects of Invention

According to the present invention, it is possible to suppress the number of times the beam divergence angle is controlled.

### BRIEF DESCRIPTION OF DRAWINGS

FIG. 1 is a diagram illustrating a configuration example of a communication system in a first embodiment.

FIG. 2 is a diagram illustrating a configuration example of a transmission part in the first embodiment.

FIG. 3 is a diagram illustrating an example of a relationship between a communication distance and a divergence angle in the first embodiment.

FIG. 4 is a flowchart illustrating an example of an operation of a communication system in the first embodiment.

FIG. 5 is a diagram illustrating a configuration example of a transmission part in a second embodiment.

FIG. 6 is a diagram illustrating an example of a hardware configuration of a communication device in each of the embodiments.

### DESCRIPTION OF EMBODIMENTS

Embodiments of the present invention will be described in detail with reference to the drawings.

### First Embodiment

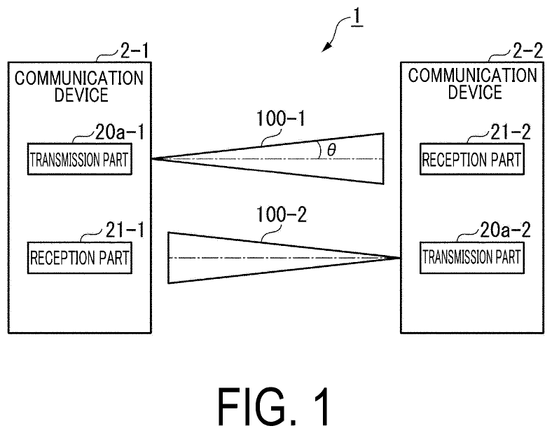

FIG. 1 is a diagram illustrating a configuration example of a communication system 1 in a first embodiment. The communication system 1 is a communication system which performs wireless communication using a directional beam. The wireless communication may be optical communication or radio wave communication. In the following description, the wireless communication is free space optical communication (FSO) as an example.

The communication system 1 includes a plurality of communication devices 2 (communication nodes). The communication device 2 includes a transmission part 20a and a reception part 21. A beam 100 is an optical signal which is directional at the time of propagating in a free space. In the following description, the symbol “θ” represents a divergence angle of the beam.

In FIG. 1, a transmission part 20a-1 of a communication device 2-1 (subject communication node) transmits a beam 100-1 to a reception part 21-2 of a communication device 2-2 (facing communication node for the communication device 2-1). The transmission part 20a-2 of the communication device 2-2 may transmit a beam 100-2 to the reception part 21-1 of the communication device 2-1.

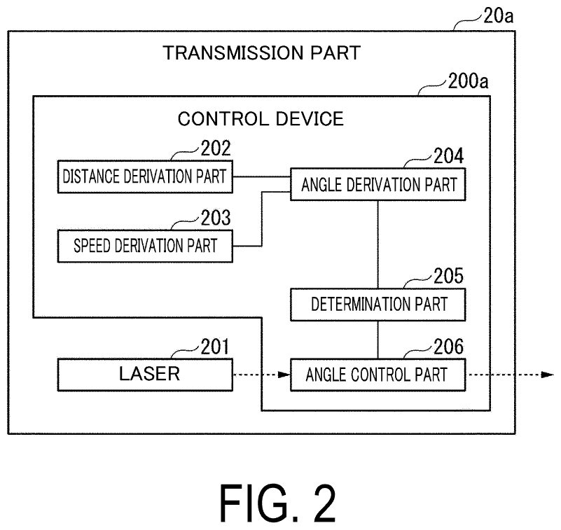

FIG. 2 is a diagram illustrating a configuration example of the transmission part 20a in the first embodiment. The transmission part 20a includes a control device 200a and a laser 201. The control device 200a includes a distance derivation part 202, a speed derivation part 203, an angle derivation part 204, a determination part 205, and an angle control part 206.

The laser 201 (oscillator) outputs a beam with a predetermined transmission power to the angle control part 206. The distance derivation part 202 derives a distance (communication distance) between the communication device 2-1 and the communication device 2-2. The distance derivation part 202 outputs a derived distance value to the angle derivation part 204.

The communication device 2 derives a communication distance on the basis of a position of the subject communication device and a position of another communication device facing the subject communication device. Here, a method using which the communication device 2 measures the position of the subject communication device is not limited to a specific measurement method. For example, the position of the subject communication device is measured using radio waves received from a plurality of artificial satellites. The plurality of artificial satellites are, for example, a plurality of global positioning system (GPS) satellites.

For example, the distance derivation part 202 may acquire a transmission power value and a beam divergence angle value of a beam transmitted from another communication device facing the subject communication device to another communication device (another facing communication device) which communicates with the subject communication device. The distance derivation part 202 acquires a value of the reception power of the beam received by the reception part 21 of the subject communication device from the reception part 21 of the subject communication device. The distance derivation part 202 may derive a communication distance using a predetermined method based on at least one of the value of the transmission power of the transmitted beam, the value of the divergence angle of the transmitted beam, the value of the reception power of the received beam, the value of the known reception diameter of the received beam, and the value of the known propagation attenuation of the beam in the free space.

For example, another communication device facing the subject communication device may include a reflection body (not shown). The reflection body is, for example, a corner reflector. The corner reflector reflects an incident beam in a direction of incidence. The angle control part 206 of the subject communication device transmits a beam used for measuring a communication distance (distance measurement beam) toward a reflection body of another communication device facing the subject communication device. The transmitted beam is reflected using a reflection plate of another communication device which faces the subject communication device. The reception part 21 of the subject communication device receives the beam reflected using the reflection plate of another communication device. The distance derivation part 202 derives the communication distance between the subject communication device and another communication device on the basis of the time when the beam is transmitted from the subject communication device, the time when the beam is received by the subject communication device, and the propagation speed of the beam (light) in the free space.

For example, when the moving object having the communication device 2 installed therein is an aircraft, a railway, or the like, a movement pattern such as a travel route and time of the mobile object may be determined in advance. The distance derivation part 202 may derive the communication distance on the basis of the movement pattern information. For example, when the communication device 2-1 (subject communication device) and the communication device 2-2 (another facing communication device) move independently of each other, the distance derivation part 202 of the communication device 2-1 derives the communication distance at predetermined intervals.

For example, when the communication device 2-1 moves and the communication device 2-2 does not move, the distance derivation part 202 of the communication device 2-1 derives the communication distance at the time of initial connection between the communication device 2-1 and the communication device 2-2. The distance derivation part 202 of the communication device 2-1 updates the communication distance at a predetermined period on the basis of the communication distance at the time of initial connection and the moving distance and the moving direction of the communication device 2-1 (amount of change in the position of the subject communication device).

The speed derivation part 203 derives a relative speed of the other communication device facing the communication device using the position of the subject communication device as the origin (reference point). The speed derivation part 203 outputs a value of the relative speed of the another facing communication device to the angle derivation part 204.

For example, the speed derivation part 203 derives a relative speed of another communication device facing the subject communication device on the basis of the amount of change in the position of the subject communication device per unit time and the amount of change in the position of the another facing communication device per unit time. Also, a method in which a speed sensor is used is also considered. The speed derivation part 203 of the communication device 2-1 (subject communication device) acquires the measurement result of a speed sensor (not shown) of the communication device 2-1 from the speed sensor. The speed derivation part 203 of the communication device 2-1 acquires the measurement result of a speed sensor (not shown) of the communication device 2-2 from the communication device 2-2. The speed derivation part 203 of the communication device 2-1 may derive a relative speed of the communication device 2-2 on the basis of the measurement results of the speed sensor (not shown) of the communication device 2-1 and the measurement results of the speed sensor (not shown) of the communication device 2-2.

For example, when the mobile object having the communication device 2 installed therein is an aircraft, a railway, or the like, a movement pattern such as a movement route and time of the mobile object may be determined in advance. The distance derivation part 202 of the communication device 2-1 may derive the relative speed of the communication device 2-2 on the basis of the movement pattern information. For example, when the communication device 2-1 and the communication device 2-2 move, the distance derivation part 202 of the communication device 2-1 derives the amount of change (relative speed) in the communication distance per unit time at a predetermined period. For example, when the communication device 2-1 moves and the communication device 2-2 does not move, the distance derivation part 202 of the communication device 2-1 derives the moving speed (relative speed) of the communication device 2-1 at a predetermined period. Note that, when the moving speed and the moving direction of the communication device 2 are constant, the relative speed only needs to be derived once.

The angle derivation part 204 acquires the derived communication distance value from the distance derivation part 202. The angle derivation part 204 acquires the derived relative speed value from the speed derivation part 203. The angle derivation part 204 of the communication device 2-1 (subject communication device) derives a divergence angle range in which communication between the communication device 2-1 and the communication device 2-2 can be maintained on the basis of the derived communication distance and relative speed. The angle derivation part 204 of the communication device 2-1 may derive a divergence angle range in which it is possible to maintain communication between the communication device 2-1 and the communication device 2-2 on the basis of the derived communication range, the derived relative speed, the value of the known reception diameter of the received beam, and the value of the known propagation attenuation of the beam in the free space. The angle derivation part 204 of the communication device 2-1 outputs a value representing the range of the derived divergence angle to the determination part 205 of the communication device 2-1.

The determination part 205 determines whether the current divergence angle of the beam 100 is included in the derived divergence angle range. When it is determined that the current divergence angle of the beam 100 is not included in the derived divergence angle range, the determination part 205 notifies the angle control part 206 of predetermined information. The predetermined information is, for example, instruction information representing changing the divergence angle of the beam.

The angle control part 206 changes (controls) the divergence angle of the beam 100 on the basis of the predetermined information that is the notification from the determination part 205. The method using which the angle control part 206 controls the divergence angle of the beam 100 is not limited to a specific control method. For example, the angle control part 206 may include a collimator lens (not shown). Since the divergence angle of the beam is approximately inversely proportional to the focal length of the collimating lens, the angle control part 206 may control the divergence angle of the beam 100, for example, by controlling the focal length of a collimator lens.

A method for deriving the divergence angle and a method for determining the control timing (control period) of the divergence angle will be explained below.

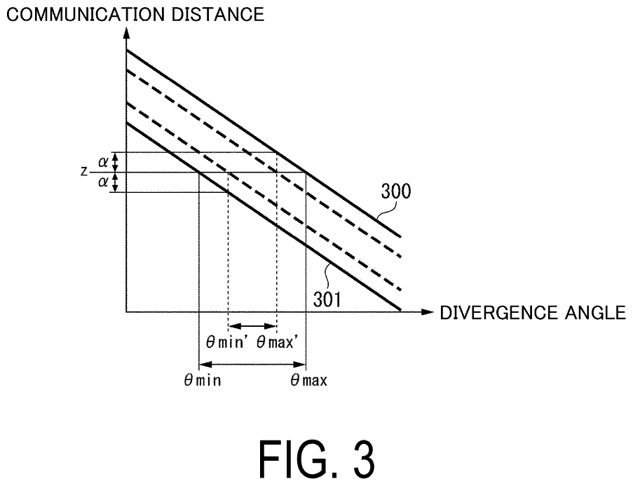

FIG. 3 is a diagram illustrating an example of a relationship between a communication distance and a divergence angle in the first embodiment. The vertical axis indicates the communication distance. The horizontal axis indicates the divergence angle. A straight line 300 represents a maximum value of the divergence angle according to the communication distance when communication of the main signal is maintained. A straight line 301 represents a minimum value of the divergence angle according to the communication distance when communication of the main signal is maintained.

The angle derivation part 204 of the communication device 2-1 derives a divergence angle range in which communication between the communication device 2-1 and the communication device 2-2 can be maintained on the basis of the derived communication range, the derived relative speed, the known value of the reception diameter of the received beam 100-1, and the known value of the propagation attenuation of the beam 100-1 in the free space.

The angle derivation part 204 of the communication device 2-1 may derive a divergence angle range in which communication between the communication device 2-1 and the communication device 2-2 can be maintained on the basis of the derived communication distance, the derived relative speed, the known value of the reception diameter of the received beam 100-1, the known value of the propagation attenuation of the beam 100-1 in the free space, and the predetermined system value in the communication system 1. The predetermined system value in the communication system 1 includes, for example, at least one of the value of the reception diameter of another communication device, the value of the transmission power of the beam transmitted from the subject communication device, the value of the control period of the beam direction, and the value of the reception power required for maintaining communication of the main signal.

The angle derivation part 204 of the communication device 2-1 derives a maximum value of the distance (optical axis deviation) between the optical axis of the beam 100-1 and the center of the receiving unit 21-2 in the control execution cycle on the basis of the control period of the direction of the beam 100 and the relative speed of the communication device 2-1 with respect to the communication device 2-1.

The angle derivation part 204 of the communication device 2-1 derives the value of the reception power of the beam 100-1 received by the reception part 21-2 when the distance (optical axis deviation) reaches the maximum value on the basis of the derived communication distance, the known value of the propagation attenuation of the beam 100-1 in the free space, the divergence angle of the beam 100-1, the known value of the reception diameter of the received beam 100-1, and the maximum distance (optical axis deviation) between the optical axis of beam 100-1 and the center of the reception part 21-2.

The angle derivation part 204 derives conditions under which the derived reception power is a threshold value or more of reception power necessary for communication of the main signal. That is to say, the angle derivation part 204 of the communication device 2-1 derives conditions under which communication with the communication device 2-2 can be maintained in the amplitude direction of the beam 100-1 (direction perpendicular to the propagation direction).

Here, the angle derivation part 204 of the communication device 2-1 derives conditions under which communication can be maintained each time at least one of the derived communication distance, the known propagation attenuation value of the beam 100-1 in free space, the divergence angle of the beam 100-1, the known reception diameter value of the received beam 100-1, and the maximum distance (optical axis deviation) between the optical axis of the beam 100-1 and the center of the reception part 21-2 is updated.

The conditions under which communication can be maintained are expressed using a combination of a communication distance and a divergence angle (relationship between a communication distance and a divergence angle). In the graph shown in FIG. 3, the conditions under which communication can be maintained are represented as a region located between the straight lines 300 and 301.

The reason why the maximum value of the divergence angle exists in the region located between the straight lines 300 and 301 is that the reception part 21-2 cannot obtain the reception power required for maintaining communication of the main signal when the divergence angle of the beam 100-1 exceeds the maximum value in accordance with the communication distance.

On the other hand, the reason why the minimum value of the divergence angle exists in the region located between the straight lines 300 and 301 is that the spread (reception diameter) of the beam 100-1 in the reception part 21-2 is small when the divergence angle of the beam 100-1 falls below the minimum value in accordance with the communication distance. That is to say, this is because, when the spread of the beam 100-1 in the reception part 21-2 is small and the distance (optical axis deviation) between the optical axis of the beam 100-1 and the center of the reception part 21-2 reaches its maximum value, the reception part 21-2 cannot obtain the reception power required for maintaining communication of the main signal.

The angle derivation part 204 of the communication device 2-1 derives a divergence angle range in which the conditions under which communication can be maintained is satisfied in accordance with the communication distance “z”. When the communication distance is “z”, the range of divergence angles which satisfy the conditions for maintaining communication is a minimum value “θₘᵢₙ” to a maximum value “θₘₐₓ”.

However, in a state in which the divergence angle of the beam 100-1 is the maximum value “θₘₐₓ”, when the communication device 2-2 (another facing communication device) is even slightly separated in the propagation direction of the beam 100-1, communication cannot be maintained. Similarly, in a state in which the divergence angle of the beam 100-1 is the minimum value “θₘᵢₙ”, when the communication device 2-2 moves away even slightly in the direction which faces the propagation direction of the beam 100-1, communication cannot be maintained.

Therefore, a positive margin value “α>0” may be provided to the communication distance “z”. The positive margin value “α” may be a value predetermined as a system value or may be a value derived in accordance with the relative speed of another facing communication device. The angle derivation part 204 uses a positive margin value to limit the range of the derived divergence angle. When the communication distance is “z±α”, the range of divergence angles which satisfies the conditions under which communication can be maintained is from the minimum value of the divergence angle “θ_{min′}” to the maximum value of the divergence angle “θ_{max′}”. The minimum value of the divergence angle “θ_{min′}” is the divergence angle at which the minimum distance at which communication can be maintained is “z−α”. The maximum value of the divergence angle “θ_{max′}” is the divergence angle at which the maximum distance at which communication can be maintained is “z+α”. Note that the margin value may be 0.

The determination part 205 determines whether the current divergence angle of the beam 100-1 is included within the range from the minimum value of the divergence angle “θ_{min′}” to the maximum value of the divergence angle “θ_{max′}”. When the current divergence angle of the beam 100-1 is not included within the range, the determination part 205 notifies the angle control part 206 to change (control) the divergence angle of the beam 100-1 so that the divergence angle of the beam 100-1 is included within the range from the minimum value “θ_{min′}” to the maximum value “θ_{max′}”.

An example of an operation of the communication system 1 will be explained below.

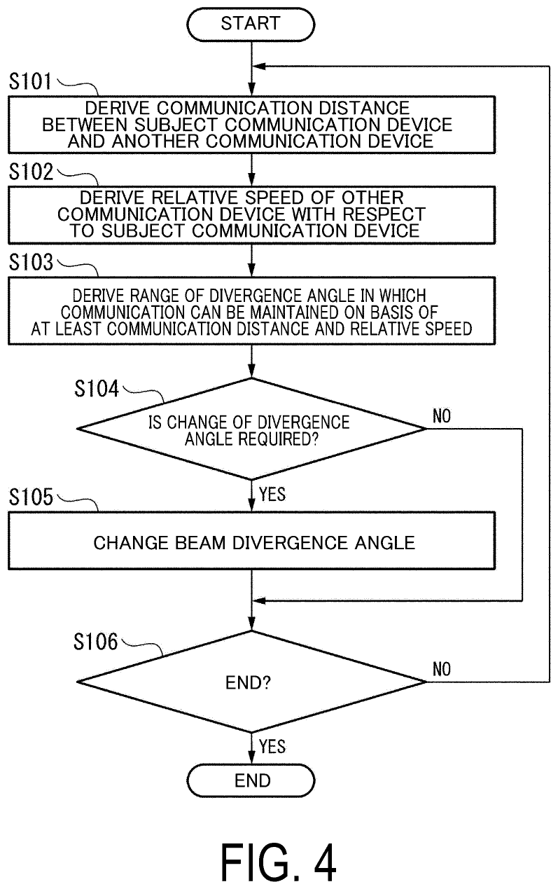

FIG. 4 is a flowchart for describing an example of the operation of the communication system 1 in the first embodiment. The distance derivation part 202 derives a communication distance between the communication device 2-1 and the communication device 2-2 (Step S101). The speed derivation part 203 derives a relative speed of the communication device 2-2 with respect to the communication device 2-1 (Step S102). The angle derivation part 204 derives the divergence angle range of the beam 100-1 in which communication between the communication device 2-1 and the communication device 2-2 can be maintained on the basis of the communication distance and the relative speed (Step S103).

The determination part 205 determines whether the divergence angle needs to be changed on the basis of the derived divergence angle range and the current divergence angle of the beam 100-1. For example, when the current divergence angle of the beam 100-1 is not included within the derived divergence angle range, the determination part 205 determines that it is necessary to change the divergence angle of the beam 100-1 (Step S104).

When it is determined that there is no need to change the divergence angle of the beam 100-1 (Step S104: NO), the process of the angle control part 206 proceeds to Step S106.

When it is determined that the divergence angle of the beam 100-1 needs to be changed (Step S104: YES), the angle control part 206 changes (controls) the divergence angle of the beam 100 (Step S105).

The angle control part 206 determines whether to end the process on the basis of a predetermined instruction signal (Step S106). When the process does not end (Step S106: NO), the process of the angle control part 206 returns to Step S101 after a predetermined time has elapsed. When the process ends (Step S106: YES), the process of the angle control part 206 ends.

As described above, the distance derivation part 202 of the communication device 2-1 derives a communication distance between the communication device 2-1 (subject communication device) which communicates using the beam 100 and the communication device 2-2 (another communication device) facing the subject communication device.) is derived. The speed derivation part 203 of the communication device 2-1 derives a relative speed of the communication device 2-2 with respect to the communication device 2-1. The angle derivation part 204 derives the range of divergence angle of the beam 100-1 in which communication between the communication device 2-1 and the communication device 2-2 can be maintained on the basis of at least the communication distance and the relative speed. The determination part 205 of the communication device 2-1 determines whether the divergence angle needs to be changed on the basis of the current divergence angle and the range of the beam 100-1. The angle control part 206 of the communication device 2-1 changes the divergence angle of the beam 100-1 when it is determined that the divergence angle needs to be changed on the basis of the current divergence angle and the range of the beam 100-1.

In this way, the communication device 2-1 changes the divergence angle of the beam 100-1 when it is necessary to change (control) the divergence angle “θ” to maintain communication. That is to say, when there is no need to change (control) the divergence angle “θ”, the communication device 2-1 does not need to change the divergence angle of the beam 100-1. Thus, it is possible to suppress the number of times the beam divergence angle is controlled. Communication can be maintained without unnecessarily shortening the control period of the divergence angle. It is possible to prevent the lifespan of the communication system from becoming shorter than necessary.

### Second Embodiment

A second embodiment and the first embodiment differ in that, in the second embodiment, the propagation attenuation of a beam transmitted from a subject communication device is unknown and in that, in the second embodiment, a reception diameter of a beam in another communication device facing a subject communication device is unknown. In the second embodiment, differences between the second embodiment and the first embodiment will be mainly explained.

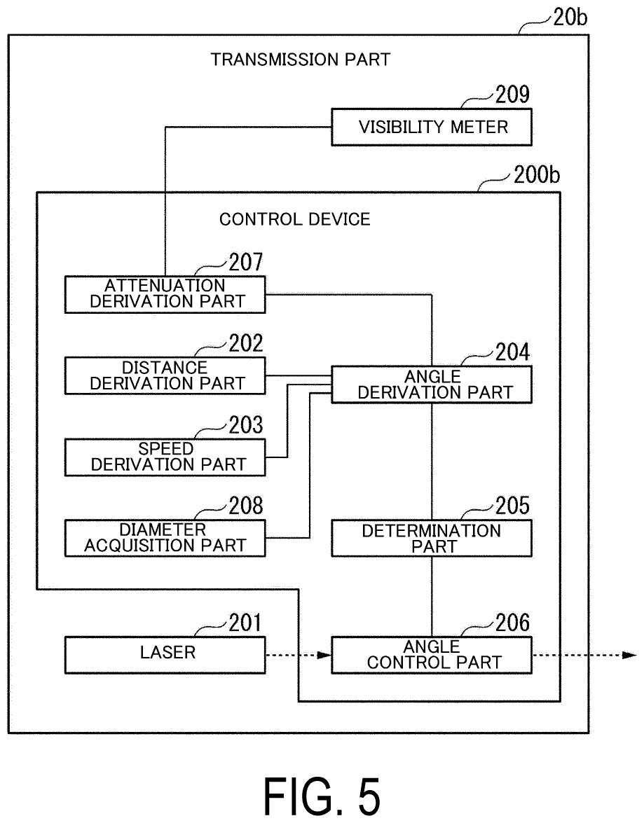

FIG. 5 is a diagram illustrating a configuration example of a transmission part 20b in the second embodiment. The communication device 2 includes the transmission part 20b and a reception part 21. The transmission part 20b includes a control device 200b and a laser 201. The control device 200b includes a distance derivation part 202, a speed derivation part 203, an angle derivation part 204, a determination part 205, an angle control part 206, an attenuation derivation part 207, and a diameter acquisition part 208. The transmission part 20b may further include a visibility meter 209.)

A method for deriving the propagation attenuation of a beam (optical signal) in a free space will be explained.

The visibility meter 209 of the transmission part 20b-1 in the communication device 2-1 receives the light transmitted from the visibility meter 209 of the transmission part 20b-2 in the communication device 2-2. The visibility meter 209 of the transmission part 20b-1 measures the intensity of scattering of the light transmitted from the visibility meter 209 of the transmission part 20b-2. The visibility meter 209 of the transmission part 20b-1 derives the visibility (turbidity of the atmosphere) in the free space between the communication device 2-1 and the communication device 2-2 on the basis of the intensity of light scattering.

The attenuation derivation part 207 derives the propagation attenuation of the beam in the free space at a predetermined period, for example, using the “Kruse model” or the “Kim model” (Reference 1: “Wafi A. Mabrouk, et al., “FSO G2T communications in tropical climate: An overview,” AIP Publishing, 2017.”) on the basis of the measured visibility and a predetermined beam wavelength.

The communication device 2-2 (another facing communication device) may notify the communication device 2-1 of the value of the transmission power of beam 100-2 transmitted from communication device 2-2. The attenuation derivation part 207 of the communication device 2-1 may derive the propagation attenuation of the beam in the free space at a predetermined period on the basis of the value of the transmission power that is a notification from the communication device 2-2, the reception power of the beam 100-2 received by the reception part 21-1 at a first communication distance, and the reception power of the beam 100-2 received by the reception part 21-1 at a second communication distance.

The communication device 2-1 and the communication device 2-2 may each include a reflection body (not shown). The angle control part 206 of the communication device 2-1 transmits a beam for measuring propagation attenuation toward a reflection body (not shown) of the communication device 2-2 at a first communication distance. The angle control part 206 of the communication device 2-1 transmits a beam for measuring propagation attenuation toward a reflection body (not shown) of the communication device 2-2 at a second communication distance. At each communication range, the propagation attenuation measurement beam is reflected by the reflection body. The attenuation derivation part 207 of the communication device 2-1 may derive the propagation attenuation of the beam in the free space at a predetermined period on the basis of the delay (difference) in the round trip time of the measurement beam reflected by the reflection body (not shown) at each communication distance.

A method for deriving a radius of a reception part (reception diameter) in the reception part 21 will be explained below. When the reception diameter of the communication device 2-2 (another facing communication device) is predetermined as a system value of the communication system 1, the diameter acquisition part 208 uses the predetermined value as the reception diameter of the beam 100-1.

When the reception diameter is not predetermined, at the time of initial connection, the angle control part 206 of the communication device 2-1 (subject communication device) transmits a signal requesting notification of the value of the reception diameter in the reception part 21-2 of the communication device 2-2 to the communication device 2-2. When the communication device 2-2 acquires a signal requesting notification of the value of the reception diameter from the communication device 2-1, the communication device 2-2 transmits the signal representing the value of the reception diameter in the reception part 21-2 of the communication device 2-2 to the communication device 2-1. The diameter acquisition part 208 of the communication device 2-1 acquires the value of the reception diameter from the signal representing the value of the reception diameter.

The diameter acquisition part 208 may acquire the value of the reception diameter in the communication device 2-2 from the communication device 2-2 by transmitting, by the angle control part 206 of the communication device 2-1 (subject communication device), a beam for acquiring the reception diameter toward the communication device 2-2.

For example, the angle control part 206 of the communication device 2-1 (subject communication device) transmits, to the communication device 2-2, a signal indicating that the communication device 2-2 starts acquiring the reception diameter. When the communication device 2-2 acquires a signal indicating that the acquisition of the reception diameter is to be started, the communication device 2-2 transmits a notification signal for the reception power in the reception part 21-2 to the communication device 2-1 at a predetermined period.

The communication device 2-2 may transmit a response signal to the communication device 2-1 when acquiring a signal indicating that acquisition of the reception diameter is to be started. The response signal may be, for example, an auxiliary management and control channel (AMCC) signal superimposed on the main signal or a signal using a link different from the link of the main signal.

The angle control part 206 of the communication device 2-1 directs the reception diameter acquisition beam toward the communication device 2-2 at a predetermined period while gradually changing the transmission angle (propagation direction) of the reception diameter acquisition beam. The angle control part 206 of the communication device 2-1 may change the divergence angle of the reception diameter acquisition beam little by little instead of changing the transmission angle of the reception diameter acquisition beam little by little.

The diameter acquisition part 208 of the communication device 2-1 derives the reception diameter in the reception part 21-2 on the basis of the notification signal for the receiving power in the reception part 21-2. When the diameter acquisition part 208 derives the reception diameter in the reception part 21-2, the angle control part 206 of the communication device 2-1 notifies the communication device 2-2 that the reception diameter has been derived. When the communication device 2-2 receives a notification concerning that the reception diameter has been derived, the communication device 2-2 ends the transmission of the reception power notification signal in the reception part 21-2.

As described above, the attenuation derivation part 207 derives the value of propagation attenuation of the beam 100-1 on the basis of at least one of the visibility between the communication device 2-1 and the communication device 2-2, the difference in reception power of the beam 100-1 at different communication distances, and the round trip time delay of the beam 100-1 at different communication distances. The diameter acquisition part 208 acquires at least one of a value based on the reception power according to the direction or the divergence angle of the beam 100-1 and a predetermined value into the reception diameter of the communication device 2-2 (another communication device).

### (Example of Hardware Configuration)

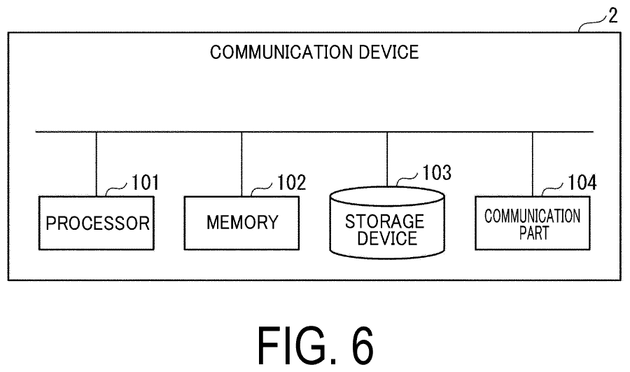

FIG. 6 is a diagram illustrating an example of a hardware configuration of the communication device 2 in each embodiment. Some or all of the functional parts of the communication device 2 are implemented as software by executing, by a processor 101 such as a central processing unit (CPU), the program stored in the storage device 103 having a non-volatile recording medium (non-temporary recording medium) and the memory 102. The program may be recorded on a computer-readable non-transitory recording medium. Examples of the computer-readable non-temporary recording media include portable media such as flexible disks, magneto-optical disks, read only memories (ROMs) and compact disc read only memories (CD-ROMs), and non-temporary recording media such as storage devices such as hard disks built into computer systems. The communication part 104 performs predetermined communication processing. The communication part 104 may obtain data and programs. The storage device 103 may store data such as system values.

A part or all of each of the functional parts of the communication device 2 may be realized, for example, using hardware including electronic circuits or circuitry using large scale integrated (LSI) circuits, application specific integrated circuits (ASICs), programmable logic devices (PLDs) or field programmable gate arrays (FPGAs), or the like.

Although the embodiments of the present invention have been described above in detail with reference to the drawings, the specific configuration is not limited to these embodiments and includes designs within the scope of the gist of the present invention.

### INDUSTRIAL APPLICABILITY

The present invention is applicable to communication systems which perform free space optical communications (FSO).

### REFERENCE SIGNS LIST

1 Communication system
2 Communication device
20a, 20b Transmission part
21 Reception part
100 Beam
101 Processor
102 Memory
103 Storage device
104 Communication part
200a, 200b Control device
201 Laser
202 Distance derivation part
203 Speed derivation part
204 Angle derivation part
205 Determination part
206 Angle control part
207 Attenuation derivation part
208 Diameter acquisition part
209 Visibility meter
300 Straight line
301 Straight line

1. A control device, comprising:
a distance derivator which derives a communication distance between a communication device which includes the control device and communicates using a beam and another communication device which faces the communication device;
a speed derivator which derives a relative speed of the another communication device with respect to the communication device;
an angle derivator which derives a range of divergence angles of a beam in which it is possible to maintain communication between the communication device and the another communication device on the basis of at least the communication distance and the relative speed; and
an angle controller which changes a divergence angle of the beam when it is determined that the divergence angle needs to be changed on the basis of the current divergence angle of the beam and the range.

2. The control device according to claim 1, wherein the angle controller changes the divergence angle of the beam when it is determined that the current divergence angle of the beam is not included within the range.

3. The control device according to claim 1, wherein the distance derivator derives the communication distance on the basis of at least one of the locations of the communication device and the another communication device, the transmission power of the beam, the reception power of the beam, the round-trip time delay between the communication device and the another communication device, and the information on the movement pattern of the mobile body having the communication device or the another communication device.

4. The control device according to claim 1, wherein the angle derivator derives the range on the basis of at least one of a value of the propagation attenuation of the beam, a value of the reception diameter in the another communication device, a value of the transmission power of the beam, and a value of a control cycle of a direction of the beam, a value of a reception power value required for maintaining main signal communication, the communication distance, and the relative speed and limits the derived range using a positive margin value.

5. The control device according to claim 4, further comprising: a diameter acquisitor which acquires at least one of a value based on reception power of the beam according to a direction or the divergence angle of the beam and a predetermined value, as a value of a reception diameter in the another communication device.

6. The control device according to claim 4, further comprising: an attenuation derivator which derives a value of propagation attenuation of the beam on the basis of at least one of visibility between the communication device and the another communication device, a difference in reception power of the beam at different communication distances, and a delay in a round trip time of the beam at different communication distances.

7. A communication system which includes a communication device which includes the control device and communicates using a beam and another communication device facing the communication device, wherein
the communication device includes:
a distance derivator which derives a communication distance between the communication device and another communication device facing the communication device;
a speed derivator which derives a relative speed of the another communication device with respect to the communication device;
an angle derivator which derives a divergence angle range of the beam in which it is possible to maintain communication between the communication device and the another communication device on the basis of at least the communication distance and the relative speed; and
an angle controller which changes a divergence angle of the beam when it is determined that the divergence angle needs to be changed on the basis of the current divergence angle of the beam and the range, and
the another communication device includes:
a receptor which acquires the beam from the angle controller.

8. A control method performed by a control device, comprising:
deriving a communication distance between a communication device which includes the control device and communicates using a beam and another communication device facing the communication device;
deriving a relative speed of the another communication device with respect to the communication device;
deriving a divergence angle range of the beam in which it is possible to maintain communication between the communication device and the another communication device on the basis of at least the communication distance and the relative speed; and
changing a divergence angle of the beam when it is determined that the divergence angle needs to be changed on the basis of the current divergence angle of the beam and the range.
